(19) United States
(12) Patent Application Publication
(10) Pub. No.: US 2015/0114811 A1
(43) Pub. Date: Apr. 30, 2015

(54) ELECTRONIC DEVICE AND BUTTON

(71) Applicants: Fu Tai Hua Industry (Shenzhen) Co., Ltd., Shenzhen (CN); HON HAI PRECISION INDUSTRY CO., LTD., New Taipei (TW)

(72) Inventor: JIAN-GUO WU, Shenzhen (CN)

(21) Appl. No.: 14/516,850

(22) Filed: Oct. 17, 2014

(30) Foreign Application Priority Data
Oct. 29, 2013 (CN) 201310519221.5

(51) Int. Cl. H01H 13/10; H01H 13/14

(52) U.S. Cl. CPC H01H 13/10; H01H 13/14; H01H 2221/058; H01H 2221/044; H01H 2221/076
USPC 200/344

(57) ABSTRACT

An electronic device includes a housing defining a receiving hole, a switch fixed in the housing, and a button which is axially true. The button comprises a fixing piece and a pressing piece. The fixing piece is fixed in the housing and defines a restriction hole. The pressing piece is partly received in the receiving hole. An end of the pressing piece is exposed out of the housing. The other end of the pressing piece is received in the restriction hole in such restrictive configuration so as to press squarely against the switch to turn it on/off. The disclosure also provides a button.

### FIELD

The present disclosure relates to a button of an electronic device.

### BACKGROUND

Electronic devices include buttons to turn on/off switches in the electronic devices. The electronic device includes a housing. The housing defines a through hole to receive the button. When the button is pressed, the button turns on/off the switch. An end of the button to touch the switch is received in the housing and is free to deviate from a central axis. Thus, when a user presses different parts of the button, the actuating end of the button may not turn on/off the function.

### BRIEF DESCRIPTION OF THE DRAWING

The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of an electronic device, according to an exemplary embodiment.

FIG. 2 is an exploded isometric view of the electronic device of FIG. 1.

FIG. 3 is similar to FIG. 2, but viewed from a different aspect.

FIG. 4 is a cross-sectional view taken along line IV-IV of FIG. 1.

### DETAILED DESCRIPTION

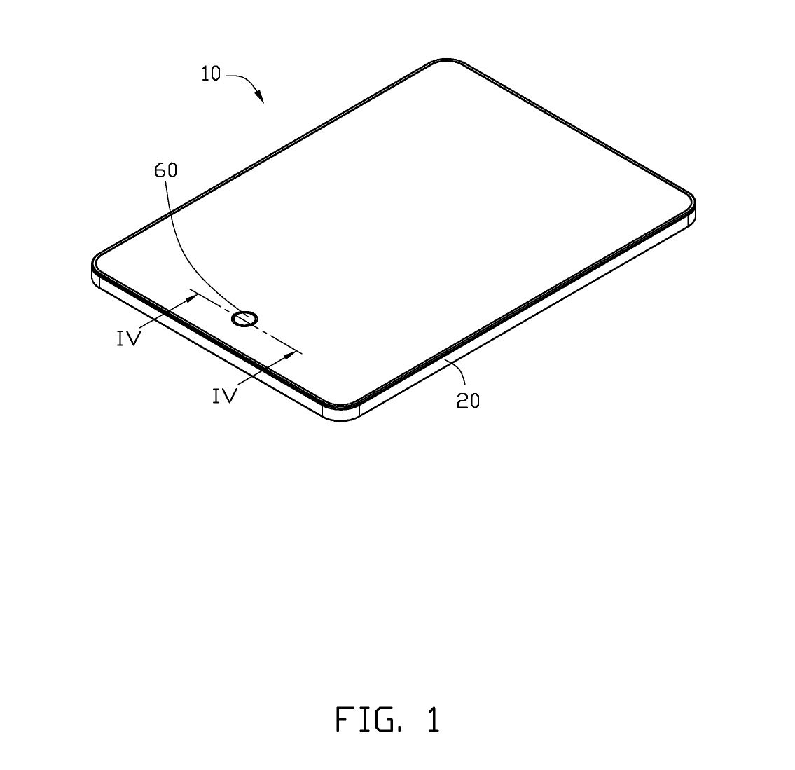

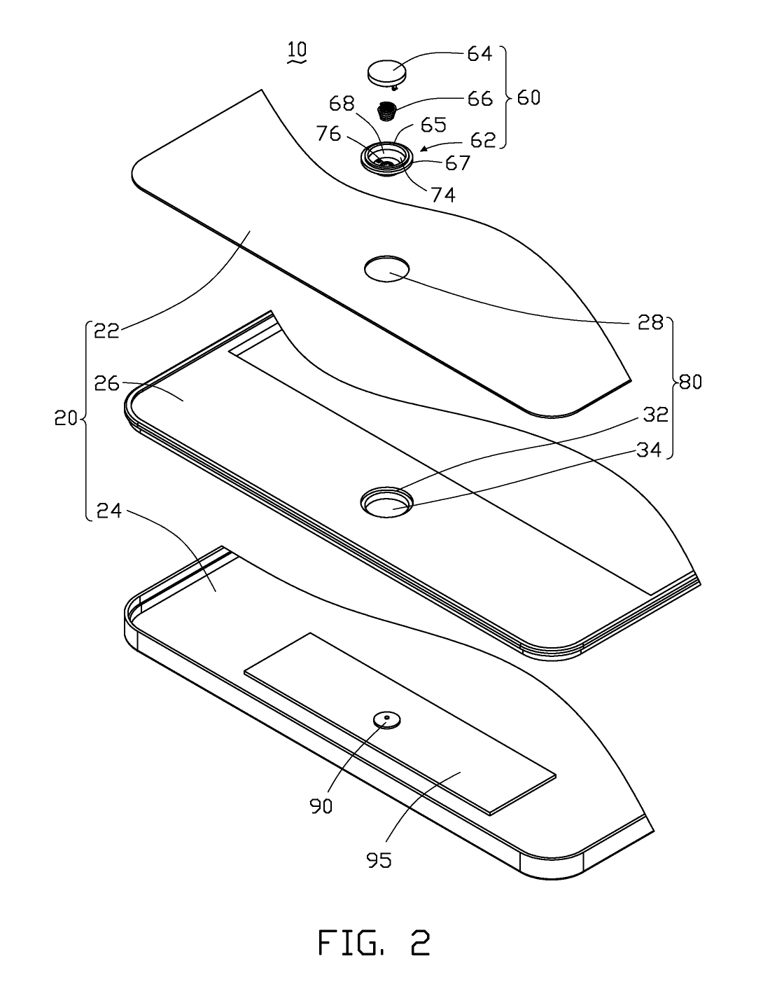

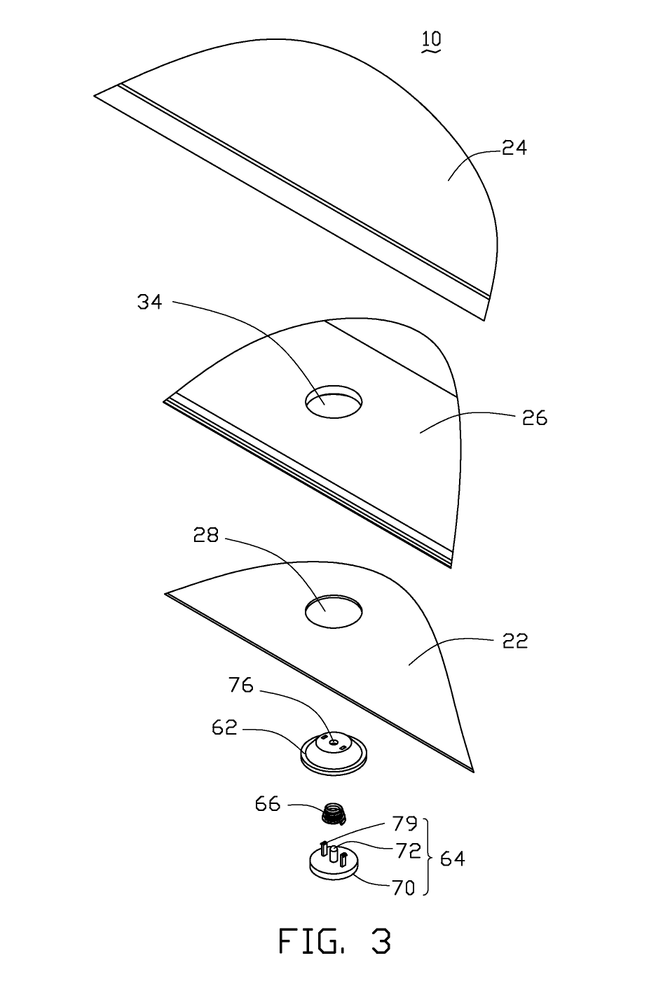

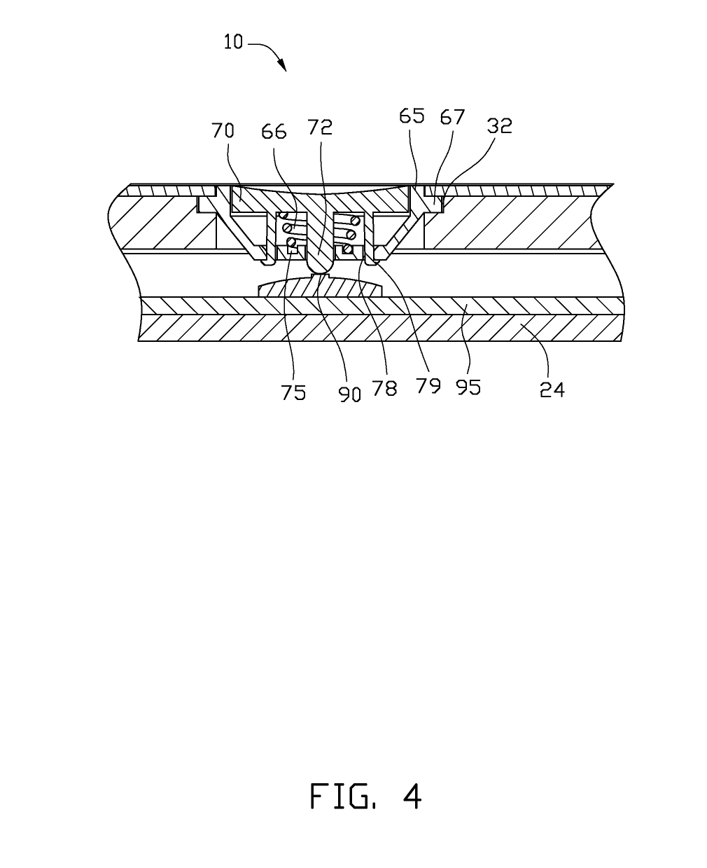

Referring to FIGS. 1-4, an electronic device includes a housing 20, a button 60, and a switch 90. The housing 20 defines a receiving hole 80. The switch 90 is arranged in the housing 20 below the receiving hole 80. The button 60 is received in the receiving hole 80 and configured to turn on/off the switch 90.

The housing 20 includes a top shell 22 for receiving a display panel (not shown), a bottom shell 24, and a tray 26. The tray 26 is arranged between the top shell 22 and the bottom shell 24. The top shell 22 is fixed to the tray 26. A circuit board 95 is fixed to the bottom shell 24. The switch 90 electrically connects to the circuit board 95. The top shell 22 defines a first through hole 28. The tray 26 defines a first hole 32 and a second hole 34 communicating with the first hole 32. The first hole 32 is closer to the first through hole 28 than to the second hole 34. A diameter of the first hole 32 is greater than that of the second hole 34. The first through hole 28, the first hole 32, and the second hole 34 together form the receiving hole 80.

The button 60 includes a fixing piece 62, a pressing piece 64, and an elastic piece 66. The fixing piece 62 is fixed to the housing 20 and defines an accepting hole 68. The fixing piece 62 includes an accepting portion 65 surrounding the accepting hole 68 and a fixing portion 67 protruding from the accepting portion 65. The fixing portion 67 is annular. The fixing portion 67 is received in the first hole 32. A part of the accepting portion 65 positioned above the fixing portion 67 is received in the first through hole 28. A part of the accepting portion 65 positioned under the fixing portion 67 is received in the second hole 34. Thus, the fixing piece 62 is fixed in the receiving hole 80 formed by the first through hole 28, the first hole 32, and the second hole 34.

The pressing piece 64 includes a pressing portion 70 and a triggering portion 72 extending from the pressing portion 70. The pressing portion 70 is received in the accepting hole 68. The fixing piece 62 includes a restriction portion 74 facing the accepting hole 68. The restriction portion 74 defines a restriction hole 76. A shape of the restriction hole 76 matches that of the triggering portion 72. An end of the triggering portion 72 away from the pressing portion 70 passes through the restriction hole 76 to face the switch 90 for turning on/off the switch 90. Because the triggering portion 72 is restricted in the restriction hole 76, whenever the pressing portion 70 is pressed, the triggering portion 72 moves only in the restriction hole 76, the triggering portion 72 does not deviate from an axis of the restriction hole 76, and the button 60 always turns on/off the switch 90.

The elastic piece 66 is sleeved on the triggering portion 72 and is positioned between the pressing portion 70 and the restriction portion 74. The elastic piece 66 provides an elastic force to reset the pressing piece 64 after the pressing portion 70 has been pressed. The pressing piece 64 further includes two hooks 79. When the pressing piece 64 is reset, the two hooks 79 hook against the restriction portion 74 to prevent the pressing portion 70 springing away from the accepting hole 68. The elastic piece 66 is a coil spring. The coil spring is tapered along its length. An end of the coil spring having the greater inner diameter is adjacent to the pressing portion 70 and the other narrower end of the coil spring is adjacent to the restriction portion 74, thus providing a variable and increasing spring rate. The restriction portion 74 further defines a second through hole 78 and a ring shaped groove 75. The two hooks 79 extend from the pressing portion 70 and are elastic. When the two hooks 79 move along the second through hole 78, the two hooks 79 are deformed. When the two hooks 79 pass through the second through hole 78, the two hooks 79 reset to hook over the restriction portion 74. The narrower end of the coil spring is received in the ring shaped groove 75 to prevent the coil spring from moving.

It is understood that the present disclosure may be embodied in other forms without departing from the spirit thereof. Thus, the present examples and embodiments are to be considered in all respects as illustrative and not restrictive, and the disclosure is not to be limited to the details given herein.

What is claimed is:

1. An electronic device comprising:
a housing defining a receiving hole;
a switch fixed in the housing; and
a button comprising:
a fixing piece fixed in the housing and defining a restriction hole; and
a pressing piece, the pressing piece partly received in the receiving hole, an end of the pressing piece exposed out of the housing, and the other end of the pressing piece received in the restriction hole and configured to press the switch to turn on/off the switch.

2. The electronic device as claimed in claim 1, wherein the restriction hole faces the switch.

3. The electronic device as claimed in claim 1, wherein a shape of the restriction hole matches that of the other end of the pressing piece.

4. The electronic device as claimed in claim 1, wherein the fixing piece comprises an accepting portion and a fixing portion protruding from the accepting portion, the receiving hole comprises two smaller holes and a greater hole positioned between the two smaller holes, the accepting portion is received in the two smaller holes and the fixing portion is received in the greater hole.

5. The electronic device as claimed in claim 4, wherein the fixing portion is ring shaped.

6. The electronic device as claimed in claim 4, wherein the accepting portion defines an accepting hole, and the pressing piece is received in the accepting hole.

7. The electronic device as claimed in claim 1, wherein the pressing piece comprises a hook, and the hook hooks against the fixing piece to prevent the pressing piece moving away from the receiving hole.

8. The electronic device as claimed in claim 1, wherein the button further comprises an elastic piece, and the elastic piece provides an elastic force to reset the pressing piece when the pressing piece turns on/off the switch.

9. The electronic device as claimed in claim 8, wherein the fixing piece comprises a restriction portion, the restriction hole is defined on the restriction portion, the pressing piece comprises a pressing portion and a triggering portion extending from the pressing portion, and the elastic piece sleeves on the triggering portion and is positioned between the pressing portion and the restriction portion.

10. The electronic device as claimed in claim 9, wherein the elastic piece is tapered along its length, an end of the elastic piece having the greater inner diameter is adjacent to the pressing portion and the other narrow end of the elastic piece is adjacent to the restriction portion.

11. The electronic device as claimed in claim 9, wherein the restriction portion defines a groove, and the narrow end of the elastic piece is received in the groove.

12. The electronic device as claimed in claim 11, wherein the elastic piece is a coil spring and the groove is annular.

13. A button for use with an electronic device, the electronic device comprising a housing defining a receiving hole, the button comprising:
a fixing piece configured to be fixed in the housing and defining a restriction hole; and
a pressing piece configured to be partly received in the receiving hole, an end of the pressing piece configured to be exposed out of the housing, the other end of the pressing piece configured to be received in the restriction hole and to press a switch fixed in the housing to turn on/off the switch.

14. The button as claimed in claim 13, wherein the pressing piece comprises a hook, and the hook hooks against the fixing piece to prevent the pressing piece moving away from the receiving hole.

15. The button as claimed in claim 13, wherein a shape of the restriction hole matches that of said the other end of the pressing piece.

16. The button as claimed in claim 13, further comprising an elastic piece, the elastic piece providing an elastic force to reset the pressing piece when the pressing piece turns on/off the switch.

17. The button as claimed in claim 16, wherein the fixing piece comprises a restriction portion, the restriction hole is defined on the restriction portion, the pressing piece comprises a pressing portion and a triggering portion extending from the pressing portion, and the elastic piece sleeves on the triggering portion and is positioned between the pressing portion and the restriction portion.

18. The button as claimed in claim 17, wherein the elastic piece is tapered along its length, and an end of the elastic piece having the greater inner diameter is adjacent to the pressing portion and the narrow end of the elastic piece is adjacent to the restriction portion.

19. The button as claimed in claim 17 wherein the restriction portion defines a groove, and the narrow end of the elastic piece is received in the groove.

20. The button as claimed in claim 19, wherein the elastic piece is a coil spring and the groove is annular.
